(19) United States
(12) Patent Application Publication
(10) Pub. No.: US 2005/0239915 A1
(43) Pub. Date: Oct. 27, 2005

(54) Systems and preparations for bio-based polyurethane foams

(75) Inventor: Ian J. Provan, Lakeland, FL (US)

Correspondence Address: BIOPOLYMERS, LLC, C/O 1453 DEVERLY DRIVE, LAKELAND, FL, 33801, US

(73) Assignees: BIOPOLYMERS, LLC; MULTIFINE, LTD

(21) Appl. No.: 11/017,607

(22) Filed: Dec. 20, 2004

Related U.S. Application Data
(60) Provisional application No. 60/530,811, filed on Dec. 18, 2003.
(60) Provisional application No. 60/559,714, filed on Apr. 6, 2004.
(60) Provisional application No. 60/567,369, filed on May 1, 2004.

(51) Int. Cl. C08J 9/00

(52) U.S. Cl. 521/99; 521/155

(57) ABSTRACT

The present invention consists of a series of bio-based polyurethane foams related to the use of such polyurethane foams for use in residential and commercial insulation industries, packaging industries and molding industries and in particular the invention includes systems and methods of manufacture and application of such bio-based polyurethane foams. The bio-based polyurethane foams are derived from castor oils, soybean oils and are not dependant on hydrocarbons, thus they are made from annually renewable natural resources.

### FIELD OF THE INVENTION

### BACKGROUND OF THE INVENTION

American Industry's Demand for Renewable Raw Materials

In 1998, a broad cross-section of American industries, non-profit groups, trade Sep. 1, 2003 associations and academic institutions developed the “The Plant/Crop Based Renewable Resources 2020 Vision” and its follow-up, “The Technology Roadmap for Plant/Crop Based Renewable Resources 2020”; both with the objective of significantly increasing industry's use of renewable, bio-based resources.

These two documents state the long-term well being of the nation and the maintenance of sustainable world leadership clearly depend on the American industries' development of reliable, renewable, bio-based resources. The major findings and conclusions of this shared vision are:

To provide continued economic growth, healthy standards of living, and strong national security for the USA, it is critical that American industry develops plant/crop based renewable resources that are a viable alternative to the current dependence on nonrenewable, diminishing fossil fuels.

Without a renewable source of building blocks for plastic goods, a time will come when petrochemical-derived plastic becomes too expensive for widespread consumption.

The USA is overly reliant on crude oil imports, importing about 50% of our oil.

If imports were to cease today, the proven fossil fuel reserves in North America would only be sufficient for 14 years at current rates of consumption.

Even with existing levels of import and no increase in use, our indigenous proven resources will only last about 28 years.

It is expected that as demand for consumable goods increases, renewable resources will have to be developed to meet an ever-increasing portion of the incremental demand.

Renewable resources are not directly competing with nonrenewable; both resources will be needed to meet demands.

Increased market pull for sustainable environmentally friendly products will create powerful incentives for companies to use and invest in plant-based building blocks.

American Industry's objectives must be to: Achieve at least 10% of basic chemical building blocks from plant-derived renewable resources by 2020 (a fivefold increase over today), with development in place to achieve a further increase to 50% by 2050.

Establish bio-based systems that are economically viable, as well as environmentally preferable.

Build collaborative partnerships among industry, growers, producers, academia and federal and state governments to develop commercial applications, to revitalize rural economies and to provide improved integration along the value-added processing and manufacturing chain.

European Union Directives on Sustainability

The European Union (EU) is the recognized world leader in addressing sustainability and environmental concerns and in requiring greater use of environmentally preferable, bio-based raw materials and products.

93/626/EEC: Council Decision of 25 Oct. 1993 on Biological Diversity was passed to promote conservation and the sustainable use of biological diversity, including biological resources, for the benefit of present and future generations. It required all European Union countries to develop and implement national strategies, plans and programs for resource conservation and sustainable use of biodiversity.

The Fifth Environmental Action Program, “Towards Sustainability”, February 1993 defined the European Union's policy and action programs regarding the environment and sustainable development as follows:
Maintain the overall quality of life
Maintain continuing access to natural resources
Avoid lasting environmental damage
Consider as “sustainable” a development that meets the needs of the present without compromising the ability of future generations to meet their own needs.

The Sixth Environment Action Program, January 2001 outlines the European Union's ambitious environmental strategy and establishes the priorities for action on the environment for the next five to ten years. It states that “greening the market” is the key to sustainable development, and its stated objectives are:
Better implement existing environmental laws
Work with business to achieve more environmentally friendly forms of production
Improve resource efficiency and greater use of sustainable resources.

### FIELD OF THE INVENTION

The present invention consists of a series of bio-based polyurethane foams related to the use of such polyurethane foams for use in residential and commercial insulation industries, packaging industries and molding industries and in particular the invention includes systems and methods of manufacture and application of such bio-based polyurethane foams.

### Polyurethane Insulation Foams

The use of sprayed polyurethane foam as insulation media is growing very rapidly, particularly in the home and commercial construction industries, which traditionally have standardized on fiberglass and or cellulose materials. Environmentally there are growing concerns that these materials could be considered carcinogenic and as such alternate materials are being sought. The vast majority of homebuilders use standard fiberglass “batt” insulation because it is considered cheap and quick. However inherent gaps, voids, improper fit in the stud cavity, its tendency to settle and its inability to address air leakage dramatically reduce the R-Values or thermal resistance performance of fiberglass in the wall and roof. Additionally the requirements of soffits and other ventilation and mechanical parts needed within the building add to the cost of fiberglass and cellulose insulation, thus these add to the cost, and are often taken for granted by the builder without taking account of these costs as part of the insulation needs. Today's consumer is demanding a housing product that is safe, environmentally sensitive and affordable in both the purchase and operation of the home.

### Polyurethane Packaging Foam

In the packaging industries, the demand for foam is on a constant increase. This is brought about by advances in electronic devices, the explosion of the internet with usage growing at an astounding 1000 percent every three years thus creating a huge demand for communications equipment. The emerging demand for high bandwidth communications lines is growing at an even faster rate, due in part to the introduction of interactive TV, High Definition Television and more sophisticated audio and video systems. The use of polyurethane foams in packaging of sensitive products can economically protect products of any size, shape and weight; it expands in seconds to form protective cushions, expanding up to 200 times its liquid volume, thus significantly reducing the cost of storage and handling. Two 55-gallon drums of liquid components when combined can create a trailer-truck load of packaging materials.

In the Packaging Foam industries the invention will provide products that will range for uses in very light densities to protect delicate equipment and glassware to higher densities for protecting large industrial parts. Specific packaging systems will meet or exceed commercial, government and military standards.

Packaging foams can be rigid, semi-rigid, flexible, open or closed cell and may be poured by hand or used in most foam dispensing equipment for pour-in-place or pre-molded parts.

Packaging foams are primarily used for void filling; light cushioning; all purpose cushioning; extra strength cushioning; heavy duty cushioning; high performance resilient cushioning; blocking and bracing; floral arrangement medium, etc.

Polyurethane touches everyone's life, many times everyday. Polyurethane is used in wide range of products in nearly every industry . . . automobiles, construction, furniture, machinery and equipment, recreational products, consumer goods, appliances, carpeting, footwear, electronics, paints and coatings, etc.

The present invention comprises the polymers known as polyurethane's and relates to a series of foam compositions and the methods of making these foam compositions, which may be flame retardant (a substance which can be added to the polymer formulation to reduce or retard the tendency to burn). The present invention is specifically designed and formulated to replace some or all currently available expensive hydrocarbon based polyols with relatively low cost, naturally occurring and readily available Bio-based vegetable oils. The present invention further is designed as an essential part of any construction that values long-term energy savings and acoustic shielding. The foam flows easily to fill the area regardless of shape or the presence of obstructions such as pipes, wires and electrical boxes. The present invention further is designed for use in the packaging industries

### BACKGROUND OF THE INVENTION

The term polyurethane refers to a thermoplastic polymer product created from the chemical reaction that results when an produced by the reaction of a polymeric isocyanate (the “A” component) and a polyol or other reactant (the “B” component) that are reactive with isocyanate, usually the hydroxyls group materials are mixed together with various cross-linkers. The polyurethane foams are formed, when mixed together by the process of simultaneous polymerization and expansion. The foam may also be tailored to variable densities, cell structures, tensile strengths and other desired physical properties. The polyurethane resins can be produced in varying forms due to properties that exhibit high elastic modulus, good electrical resistance, and high moisture resistant crystalline structures.

Due to the finite supply of fossil fuels and the high cost of energy, the need to design energy-efficient buildings that are also economical becomes important. Brick and concrete block, as high mass building materials, have the inherent energy saving feature of thermal storage capacity—or more commonly referred to as “thermal mass”. Brick and concrete block provide a unique energy efficient ‘building envelope’ due to their high thermal mass. Thermal mass is the characteristic of heat capacity and surface area capable of affecting building thermal loads by storing heat and releasing it at a later time. Materials with high thermal mass react more slowly to temperature fluctuations and thereby reduce peak energy loads.

The polyurethane foams claimed under the present invention can be used in many applications but the present invention is aimed at the insulation market, the packaging industries and molding industries The present environment is concerned with global warming, heat conservation and reduced CFC's and HCFC's.

Some of the applications where polyurethane foam can be an effective insulation and acoustical barrier are:

Sprayed polyurethane foam under the present invention can be applied to roofing as a liquid, expanding approximately some 40 times its original liquid volume, and can be used to fill voids, cracks and crevices as well as providing an air-tight, weatherproof membrane for the roof. The foam dries in seconds following application and fully adheres to the substrate. Due to the lightweight of the foam it adds very little additional weight to the roof; the versatility of the polyurethane foam lends itself to on-site applications. Residential, commercial and industrial constructions are all candidates for polyurethane foam applications. The foam adds strength to metal and wood stud cavities due to excellent adhesion and strength to weight ratios.

Other applications where the polyurethane foam can be utilized are—corrosion protection, containment, waterproofing, perimeter wall, sound walls on interstate highways, floatation devices, spray molding, et al.

What is needed is a method of making a polyurethane product(s) from relatively Inexpensive bio-based starting materials without the need to use expensive starting materials such as hydrocarbon-based polyols.

The production of the A side and the B side components, once completed can be easily mixed, the resulting liquid mixture can be sprayed or molded into the desired shape or form. The flexible polyurethane reactant foam system can be modified to produce various densities, strengths and cell structures. The procedures that can be used are identical to those employed utilizing industrial hydrocarbon based polyols.

Polymeric isocyanates which can be used in the present invention include diphenylmethane diisocyanate (MDI) [CAS number 9016-87-9], toluene 2-4 diisocyanate (2-2-TDI), naphthalene 1,5 diisocyanate (NDI), diphenylmethane 2,4′ diisocyanate (2,4′MDI); mixtures of these products may also be used. The present invention can use other ranges of isocyanates as are commonly available from manufacturers such as, BASF, Bayer, Dow Chemical Company, Huntsman etc.

A variety of polyurethane foams of differing rigidities and densities were prepared from different catalysts initiators, fillers and varying amounts of these ingredients. The resulting ingredients were combined in plastic containers, and thoroughly mixed. The compositions were allowed to expand freely and left to cure. Examples of this foam system are shown as examples 1 through 17.

This invention is further illustrated by the following examples, which are not to be construed in any way as imposing limitations upon the scope thereof On the contrary, it is to be clearly understood that resort may be had to various other embodiments, modifications, and equivalents thereof which, after reading the description herein, may suggest themselves to those skilled in the art without departing from the spirit of the present invention. For example, it is to be understood that the amounts of reagents used in the following Examples are approximate and that those skilled in the art might vary these amounts and ratios by as much as 30% without departing from the spirit of the present invention.

### EXAMPLE 1

A bio-based polyurethane foam was prepared by using the following components:

Ratios: A Side:B Side 1:1.

| “A” Side Component: | | |
|---|---|---|
| Polymeric MDI | 100 | parts by weight |
| (Bayer Product Mondur MR Light) | | |
| “B” Side Component: | | |
| Castor derived Polyol Grade 1 | 27.0 | parts by weight |
| H 360/P9157 Polyol (Harvin/Pelron) | 41.0 | parts by weight |
| Water | 2.0 | parts by weight |
| DEG (Diethylene Glycol) | 4.5 | parts by weight |
| DPG (Dipropylene Glycol) | 2.4 | parts by weight |
| PEG 400 (Polyethylene Glycol) | 11.0 | parts by weight |
| RC 105 Catalyst (Rhein Chemie) | 0.6 | parts by weight |
| Desmorapid PV tertiary amine (Rhein Chemie) | 0.2 | parts by weight |
| Siloxanes 9900 | 1.5 | parts by weight |
| Cyclo-pentane | 10.0 | parts by weight |

Note:
Castor based polyols may be substituted with Polyol ”NoveonH”-Soy based polyol.
The “B” side components are mixed together in a suitable mixing vessel using a specially designed high shear mixer and blending the components for a period of fifteen minutes.

Following the preparation of the B side, the two components were mixed together in a container for about 30 seconds. The reaction of side A with side B resulted in the immediate formation of foam cells, which were allowed to freely rise within to the container. The foam cells bonded to all surfaces of the container and the resultant foam remained “tacky” for approximately 3 minutes until completely cured. The resulting foam possessed good adherence properties, suitable for thermal container applications as is explained in U.S. Pat. No. 6,557,370 and subsequent issued patents to the inventor. The density of the resultant foam was 1.8 pounds per cubic foot. Slight variations of the components in the “B” side can be made to change the range of densities and thermal components.

### EXAMPLE 2

A bio-based polyurethane foam was prepared by using the following components:

Ratios: A Side: B Side 1:1

| “A” Side Component: | | |
|---|---|---|
| Polymeric MDI | 100.0 | parts by weight |
| (Bayer Product Mondur MR Light) | | |
| B” Side Component: | | |
| Castor derived Polyol Grade 1 | 43.0 | parts by weight |
| H 360/P9157 Polyol (Harvin/Pelron) | 39.7 | parts by weight |
| Water | 2.0 | parts by weight |
| DMEA (Dimethylethanol Amine) | 0.1 | parts by weight |
| DC2 | 0.2 | parts by weight |
| NP9 Tergitol (Dow) | 2.0 | parts by weight |
| P9339 (Pelron) | 12.0 | parts by weight |
| Siloxanes 9900 | 1.0 | parts by weight |

The “B” side components are mixed together in a suitable mixing vessel using a specially designed high shear mixer and blending the components for a period of fifteen minutes.

Following the preparation of the B side, the two components were mixed together in a container for about 30 seconds. The reaction of side A with side B resulted in the immediate formation of foam cells, which were allowed to freely rise external to the container. The foam cells bonded to all surfaces of the container and the resultant foam remained “tacky” for approximately 10 minutes until completely cured. The resulting foam possessed good adherence properties, suitable for molding various products. The density of the resultant foam was 3.3 pounds per cubic foot

### EXAMPLE 3

A bio-based polyurethane foam was prepared by using the following components:

Ratios: A Side: B Side 1:1

| “A” Side Component: | | |
|---|---|---|
| Polymeric MDI | 100.0 | parts by weight |
| (Bayer Product Mondur MR Light) | | |
| “B” Side Component: | | |
| Soybean derived Polyol “H” (Noveon) | 27.0 | parts by weight |
| H 360/P9157 Polyol (Harvin/Pelron) | 70.0 | parts by weight |
| Water | 0.2 | parts by weight |
| RC 108 (Rhein Chemie) | 0.2 | parts by weight |
| RC 105 (Rhein Chemie) | 0.4 | parts by weight |
| Siloxanes 9900 | 2.0 | parts by weight |

The “B” side components are mixed together in a suitable mixing vessel using a specially designed high shear mixer and blending the components for a period of fifteen minutes.

Following the preparation of the B side, the two components were mixed together in a container for about 30 seconds. The reaction of side A with side B resulted in the immediate formation of foam cells, which were allowed to freely rise external to the container. The foam cells bonded to all surfaces of the container and the resultant foam remained “tacky” for approximately 10 minutes until completely cured. The resulting foam possessed good adherence properties, suitable for molding various products. The density of the resultant foam was 10 pounds per cubic foot

### EXAMPLE 4

A bio-based polyurethane foam was prepared by using the following components:

Ratios: A Side: B Side 1:1

| “A” Side Component: | | |
|---|---|---|
| Polymeric MDI | 100.0 | parts by weight |
| (Bayer Product Mondur MR Light) | | |
| “B” Side Component: | | |
| Castor derived Polyol Grade 1 | 30.0 | parts by weight |
| DEG (Diethylene Glycol) | 5.0 | parts by weight |
| H 360/P9157 Polyol (Harvin/Pelron) | 20.0 | parts by weight |
| Water | 0.6 | parts by weight |
| NP 9 (Tergitol) | 2.0 | parts by weight |
| RB 79/P9457 Saytex (Pelron) | 8.0 | parts by weight |
| 350X | 17.0 | parts by weight |
| TCPP/P9338 (tris-(chlorisopropyl)phosphate) | 12.0 | parts by weight |
| (Pelron) | | |
| 70-600 | 5.0 | parts by weight |
| Siloxanes 9900 | 0.5 | parts by weight |

### EXAMPLE 5

A bio-based polyurethane boardstock foam was prepared by using the following components:

Ratios: A Side 1:1 B Side

| “A” Side Component: | | |
|---|---|---|
| Polymeric MDI | 100 | parts by weight |
| (Bayer Product Mondur MR Light) | | |
| “B” Side Component: | | |
| Soybean Polyol Epoxidized ESO 775(Ferro) | 10.0 | parts by weight |
| 71-357 Polyol Pelron) | 49.4 | parts by weight |
| Water | 2.5 | parts by weight |
| 470X/P737 Voranol (Pelron) | 25.0 | parts by weight |
| RB79/P9457 (Pelron) | 10.0 | parts by weight |
| PC5 | 0.2 | parts by weight |
| NP 9 Tergitol (Dow) | 2.0 | parts by weight |
| Siloxanes 9900 | 0.8 | parts by weight |
| RC 201 (Rhein Chemie) | 0.3 | parts by weight |
| DC2 | 0.2 | parts by weight |

The “B” side components are mixed together in a suitable mixing vessel using a specially designed high shear mixer and blending the components for a period of fifteen minutes.

Following the preparation of the B side, the two components were mixed together along with a blowing agent 245fa in a container for about 30 seconds. The reaction of side A with side B resulted in the immediate formation of foam cells, which were allowed to freely rise within to the container. The foam cells bonded to all surfaces of the container and the resultant foam remained “tacky” for approximately 3 minutes until completely cured. The density of the resultant foam was 1.8 pounds per cubic foot. Slight variations of the components in the “B” side can be made to change the range of densities and performance characteristics. Example 4 and 5 are illustration of these variations these polyurethane foam formulas are eminently suitable for the manufacture of foam insulation “laminated boardstock”.

### EXAMPLE 6

A bio-based polyurethane boardstock foam was prepared by using the following components:

Ratios: A Side 1:1 B Side

| “A” Side Component: | | |
|---|---|---|
| Polymeric MDI | 100.0 | parts by weight |
| (Bayer Product Mondur MR Light) | | |
| “B” Side Component: | | |
| Soybean Polyol Epoxidized ESO 775 (Ferro) | 15.0 | parts by weight |
| 71-357 Polyol | 49.4 | parts by weight |
| Water | 3.0 | parts by weight |
| 470X/P737 Voranol (Pelron) | 25.0 | parts by weight |
| TCPP tris-(chlorisopropyl) phosphate) | 5.0 | parts by weight |
| (Pelron) | | |
| PC5 | 1.0 | parts by weight |
| NP 9 Tergitol (Dow) | 2.0 | parts by weight |
| Siloxanes 9900 | 0.8 | parts by weight |
| RC201 (Rheine Chemie) | 0.3 | parts by weight |
| DC2 | 0.2 | parts by weight |

The “B” side components are mixed together in a suitable mixing vessel using a specially designed high shear mixer and blending the components for a period of fifteen minutes.

Following the preparation of the B side, the two components were mixed together in a container along with a blowing agent 245af for about 30 seconds. The reaction of side A with side B resulted in the immediate formation of foam cells, which were allowed to freely rise external to the container. The foam cells bonded to all surfaces of the container and the resultant foam remained “tacky” for approximately 10 minutes until completely cured. The resulting foam possessed good adherence properties; this polyurethane foam is eminently suitable for the manufacture of foam insulation “laminated boardstock” products. The density of the resultant foam was 2.0 pounds per cubic foot

### EXAMPLE 7

A bio-based polyurethane boardstock foam was prepared by using the following components:

Ratios: A Side 1:1 B Side

| “A” Side Component: | | |
|---|---|---|
| Polymeric MDI | 100 | parts by weight |
| (Bayer Product Mondur MR Light) | | |
| “B” Side Component: | | |
| Soybean Polyol Amid 14YP172 (Pelron) | 12.0 | parts by weight |
| 71-357 Polyol (Arch) | 47.2 | parts by weight |
| 76-120 Polyol (Arch) | 5.0 | parts by weight |
| Water | 3.5 | parts by weight |
| Oxid 198 Arch | 10.0 | parts by weight |
| RB79/P9457 (Pelron) | 5.0 | parts by weight |
| TCPP (tris-(chlorisopropyl)phosphate) | 9.0 | parts by weight |
| (Pelron) | | |
| PC5 | 0.2 | parts by weight |
| NP 9 Tergitol (Dow) | 2.0 | parts by weight |
| Siloxanes 9900 | 0.8 | parts by weight |
| T12 catalyst | 0.3 | parts by weight |
| DC2 | 0.2 | parts by weight |

The “B” side components are mixed together in a suitable mixing vessel using a specially designed high shear mixer and blending the components for a period of fifteen minutes.

Following the preparation of the B side, the two components were mixed together along with a blowing agent 245fa (3.5 parts by weight) in a container for about 30 seconds. The reaction of side A with side B resulted in the immediate formation of foam cells, which were allowed to freely rise within to the container. The foam cells bonded to all surfaces of the container and the resultant foam remained “tacky” for approximately 3 minutes until completely cured. The density of the resultant foam was 1.8 pounds per cubic foot. Slight variations of the components in the “B” side can be made to change the range of densities and performance characteristics. Example 4, 5 and 6 are illustration of these variations These polyurethane foam formulas are eminently suitable for the manufacture of foam insulation “laminated boardstock”.

### EXAMPLE 8

A bio-based polyurethane boardstock foam was prepared by using the following components:

Ratios: A Side 1:1 B Side

| “A” Side Component: | | |
|---|---|---|
| Polymeric MDI | 100.0 | parts by weight |
| (Bayer Product Mondur MR Light) | | |
| “B” Side Component: | | |
| Soybean Polyol Amid 14YP172 (Pelron) | 12.0 | parts by weight |
| 71-357 Polyol (Arch) | 25.0 | parts by weight |
| 76-120 Polyol (Arch) | 8.2 | parts by weight |
| Water | 3.5 | parts by weight |
| Oxid 198 Arch | 10.0 | parts by weight |
| RB79/P9457 (Pelron) | 10.0 | parts by weight |
| TCPP (tris-(chlorisopropyl)phosphate) | 18.0 | parts by weight |
| (Pelron) | | |
| PC5 | 1.0 | parts by weight |
| NP 9 Tergitol (Dow) | 2.0 | parts by weight |
| Siloxanes 9900 | 0.8 | parts by weight |
| T12 catalyst | 0.3 | parts by weight |
| DC2 | 0.2 | parts by weight |

The “B” side components are mixed together in a suitable mixing vessel using a specially designed high shear mixer and blending the components for a period of fifteen minutes.

Following the preparation of the B side, the two components were mixed together in a container along with a blowing agent 245af (3.5 parts by weight) for about 30 seconds. The reaction of side A with side B resulted in the immediate formation of foam cells, which were allowed to freely rise external to the container. The foam cells bonded to all surfaces of the container and the resultant foam remained “tacky” for approximately 10 minutes until completely cured. The resulting foam possessed good adherence properties, This polyurethane foam is eminently suitable for the manufacture of foam insulation “laminated boardstock” products. The density of the resultant foam was 2.0 pounds per cubic foot.

### EXAMPLE 9

A bio-based polyurethane foam was prepared by using the following components:

Ratios: A Side 1:1 B Side

| “A” Side Component: | | |
|---|---|---|
| Polymeric MDI | 100.0 | parts by weight |
| (Bayer Product Mondur MR Light) | | |
| “B” Side Component: | | |
| Castor derived Polyol Grade 1 | 20.0 | parts by weight |
| H 360/P9157 Polyol (Harvin/Pelron) | 27.7 | parts by weight |
| RC 201 (Rhein Chemie) | 0.5 | parts by weight |
| DEG Diethylene Glycol) | 5.0 | parts by weight |
| TCPP (tris-(chlorisopropyl)phosphate) | 9.0 | parts by weight |
| (Pelron) | | |
| B8870 Tegostab (Goldschmidt) | 1.0 | parts by weight |
| DMEA (Dimethylethanol Amine) Rhein Chemie) | 3.0 | parts by weight |
| Cyclopentane | 2.0 | parts by weight |

The “B” side components are mixed together in a suitable mixing vessel using a specially designed high shear mixer and blending the components for a period of fifteen minutes.

Following the preparation of the B side, the two components were mixed together in a container for about 30 seconds. The reaction of side A with side B resulted in the immediate formation (5 seconds) of foam cells, which were allowed to freely rise external to the container. The foam cells bonded to all surfaces of the container and the resultant foam remained “tacky” for approximately 10 minutes until completely cured. The resulting foam possessed good adherence properties, suitable for polyurethane roofing foams. The density of the resultant foam was 2.35 pounds per cubic foot. Slight variations in the formulation can produce higher or lower density products suitable for roof applications.

### EXAMPLE 10

A bio-based polyurethane foam was prepared by using the following components:

Ratios: 1:1

| “A” Side Component: | | |
|---|---|---|
| Polymeric MDI | 100.0 | parts by weight |
| (Bayer Product Mondur MR Light) | | |
| “B” Side Component: | | |
| Soybean Polyol Epoxidized ESO 775 (Ferro | 32.0 | parts by weight |
| H 360/P9157 Polyol (Harvin/Pelron) | 17.4 | parts by weight |
| Water | 6.0 | parts by weight |
| 0-500 Ortegol (Goldschmidt) | 0.1 | parts by weight |
| RB 79/P9457 (Pelron | 18.0 | parts by weight |
| 0-500 Ortegol (Goldschmidt) | 0.1 | parts by weight |
| RB 79/P9457 (Pelron | 18.0 | parts by weight |
| TCPP (tris-(chlorisopropyl)phosphate) | 20.0 | parts by weight |
| (Pelron) | | |
| B-8870 Tegostab (Goldschmidt) | 2.0 | parts by weight |
| RC 201 (Rhein Chemie) | 0.5 | parts by weight |
| RC 108 (Rhein Chemie) | 1.0 | parts by weight |

The “B” side components are mixed together in a suitable mixing vessel using a specially designed high shear mixer and blending the components for a period of fifteen minutes.

Following the preparation of the B side, the two components were mixed together in a container for about 30 seconds. The reaction of side A with side B resulted in the immediate formation (5 seconds) of foam cells, which were allowed to freely rise external to the container. The foam cells bonded to all surfaces of the container and the resultant foam remained “tacky” for approximately 10 minutes until completely cured. The resulting foam possessed good adherence properties, suitable for molding various products. The density of the resultant foam was 1 pound per cubic foot. This polyurethane foam is an ideal product for interior insulation of residential/commercial building requiring higher R values and is an open cell material.

### EXAMPLE 11

A bio-based polyurethane foam was prepared by using the following components:

Ratios: 1:1

| “A” Side Comoonent: | | |
|---|---|---|
| Polymeric MDI | 100.0 | parts by weight |
| (Bayer Product Mondur MR Light) | | |
| “B” Side Component: | | |
| Soybean Polyol Epoxidized ESO 775 (Ferro) | 20.0 | parts by weight |
| Polyol 744 (Pelron) | 20.4 | parts by weight |
| RB 79/P9157 (Pelron) | 14.0 | parts by weight |
| TCPP (tris-(chlorisopropyl)phosphate) | 17.5 | parts by weight |
| (Pelron) | | |
| 470X/P737 (Pelron) | 15.5 | parts by weight |
| B-8870 Tegostab (Goldshmidt) | 1.0 | parts by weight |
| RC 201 (Rhein Chemie) | 1.5 | parts by weight |
| RC 108 (Rhein Chemie) | 2.0 | parts by weight |
| Cyclopentane | 3.0 | parts by weight |

The “B” side components are mixed together in a suitable mixing vessel using a specially designed high shear mixer and blending the components for a period of fifteen minutes.

Following the preparation of the B side, the two components were mixed together in a container for about 30 seconds. The reaction of side A with side B resulted in the immediate formation (5 seconds) of foam cells, which were allowed to freely rise external to the container. The foam cells bonded to all surfaces of the container and the resultant foam remained “tacky” for approximately 10 minutes until completely cured. The resulting foam possessed good adherence properties, suitable for molding various products. The density of the resultant foam was 1 pound per cubic foot with a very high bio-based content in the finished foam at 20.2 percent. This is a winter grade formulation and can be modified for spring and summer formulation be changing catalyst percentage of RC 201 (1 part by weight) and RC 108 (1.5 parts by weight) with slight increase in the fire retardant TCPP (18.5 parts by weight) This polyurethane foam is an ideal product for interior insulation of residential/commercial building requiring higher R values and is an open cell material.

### EXAMPLE 12

A polyurethane foam was prepared by using the following components:

Ratios: 1:1

| “A” Side Component: | | |
|---|---|---|
| Polymeric MDI | 100.0 | parts by weight |
| (Bayer Product Mondur MR Light) | | |
| “B” Side Component: | | |
| Soybean Polyol Epoxidized ESO 775 (Ferro) | 15.0 | parts by weight |
| Polyol H (Noveon) | 24.5 | parts by weight |
| Water | 5.0 | parts by weight |
| 0-500 Ortegol (Goldshmidt) | 0.2 | parts by weight |
| RB79/P9157 (Pelron) | 12.0 | parts by weight |
| TCPP (tris-(chlorisopropyl)phosphate) | 20.0 | parts by weight |
| (Pelron) | | |
| 470X/P737 (Pelron) | 16.0 | parts by weight |
| B-8870 Tegostab (Goldshmidt) | 0.8 | parts by weight |
| RC 201 (Rhein Chemie) | 1.5 | parts by weight |
| RC 108 (Rhein Chemie) | 2.0 | parts by weight |
| Cyclopentane | 3.0 | parts by weight |

The “B” side components are mixed together in a suitable mixing vessel using a specially designed high shear mixer and blending the components for a period of forty to fifty minutes.

Following the preparation of the B side, the two components were mixed together in a container for about 30 seconds. The reaction of side A with side B resulted in the immediate formation (5 seconds) of foam cells, which were allowed to freely rise external to the container. The foam cells bonded to all surfaces of the container and the resultant foam remained “tacky” for approximately 10 minutes until completely cured. The resulting foam possessed good adherence properties, suitable for molding various products requiring low densities and having the need for high content bio-based products. The density of the resultant foam was 1 pound per cubic foot with a very high bio-based content in the finished foam at 19.75 percent. This is a winter grade formulation and can be modified for spring and summer formulation by changing catalyst percentage of RC 201 (1 part by weight) and RC 108 (1.5 parts by weight) with slight residential/commercial building requiring higher R values and is an open cell material.

### EXAMPLE 13

A bio-based polyurethane foam was prepared by using the following components:

Ratios: A Side: B Side 1:1

| “A” Side Component: | | |
|---|---|---|
| Polymeric MDI | 100.0 | parts by weight |
| (Bayer Product Mondur MR Light) | | |
| “B” Side Component | | |
| Soybean Polyol Epoxidized ESO 775 (Ferro) | 37.4 | parts by weight |
| H 360/P9157 Polyol (Harvin/Pelron) | 13.0 | parts by weight |
| 470-X/P737 (Pelron) | 21.5 | parts by weight |
| Water | 20.0 | parts by weight |
| B8870 Tegostab (Goldschmidt) | 2.0 | parts by weight |
| NP 9 Tergitol (Dow) | 3.0 | parts by weight |
| 0-500 Ortegol (Goldschmidt) | 0.1 | parts by weight |
| RC 108 (Rhein Chemie) | 2.5 | parts by weight |
| RC 201 (Rhein Chemie) | 0.5 | parts by weight |

The “B” side components are mixed together in a suitable mixing vessel using a specially designed high shear mixer and blending the components for a period of forty to fifty minutes.

Following the preparation of the B side, the two components were mixed together in a container for about 30 seconds. The reaction of side A with side B resulted in the immediate formation of foam cells, which were allowed to freely rise external to the container. The foam cells bonded to all surfaces of the container and the resultant foam remained “tacky” for approximately 10 minutes until completely cured. The resulting foam possessed excellent adherence properties, suitable for spray foam insulation products. The density of the resultant foam was 0.5 pounds per cubic foot. This product is designed to serve polyurethane foam packing industries.

### EXAMPLE 14

A bio-based polyurethane foam was prepared by using the following components:

Ratios: A Side: B Side 1:1

| “A” Side Component: | | |
|---|---|---|
| Polymeric MDI | 100.0 | parts by weight |
| (Bayer Product Mondur MR Light) | | |
| “B” Side Component | | |
| Polyol P676 (Pelron) | 59.0 | parts by weight |
| TCPP (tris-(chlorisopropyl)phosphate) | 12.0 | parts by weight |
| (Pelron) | | |
| B8870 Tegostab (Goldschmidt) | 1.5 | parts by weight |
| 0-500 Ortegol (Goldschmidt) | 0.5 | parts by weight |
| Water | 18.0 | parts by weight |
| RC 108 (Rhein Chemie) | 2.0 | parts by weight |
| RC 201 (Rhein Chemie) | 2.0 | parts by weight |
| TEA Triethanol Amine | 3.0 | parts by weight |
| Cyclopentane | 2.0 | parts by weight |

The “B” side components are mixed together in a suitable mixing vessel using a specially designed high shear mixer and blending the components for a period of forty to fifty minutes.

Following the preparation of the B side, the two components were mixed together in a container for about 30 seconds. The reaction of side A with side B resulted in the immediate formation of foam cells, which were allowed to freely rise external to the container. The foam cells bonded to all surfaces of the container and the resultant foam remained “tacky” for approximately 10 minutes until completely cured. The resulting foam possessed excellent adherence properties, suitable for pour foam packaging foams and had a very high bio-based content (29.5%). The foam also has excellent flexible characteristics eminently suitable for cushioning of delicate products requiring careful handling for shipping purposes. The density of the resultant foam was 0.5 pounds per cubic foot. This product is designed to serve polyurethane foam packing industries.

### EXAMPLE 15

A bio-based polyurethane foam was prepared by using the following components:

Ratios: A Side: B Side 1:1

| “A” Side Component: | | |
|---|---|---|
| Polymeric MDI | 100.0 | parts by weight |
| (Bayer Product Mondur MR Light) | | |
| “B” Side Component: | | |
| Castor derived Polyol Grade 1 | 22.0 | parts by weight |
| B 8870 Tegostab (Goldschmidt) | 1.0 | parts by weight |
| DC 2 | 0.3 | parts by weight |
| H 360/P9157 Polyol (Harvin/Pelron) | 18.0 | parts by weight |
| Water | 10.0 | parts by weight |
| NP 9 Tergitol (Dow) | 2.0 | parts by weight |
| RC 108 (Rhein Chemie) | 2.3 | parts by weight |
| 470 X/P737 (Pelron) | 20.6 | parts by weight |
| TCPP (tris-(chlorisopropyl)phosphate) | 20.0 | parts by weight |
| (Pelron) | | |
| T 12 | 0.8 | parts by weight |
| Cyclopentane | 3.0 | parts by weight |

The “B” side components are mixed together in a suitable mixing vessel using a specially designed high shear mixer and blending the components for a period of fifteen minutes.

Following the preparation of the B side, the two components were mixed together in a container for about 30 seconds. The reaction of side A with side B resulted in the immediate formation of foam cells, which were allowed to freely rise external to the container. The foam cells bonded to all surfaces of the container and the resultant foam remained “tacky” for approximately 10 minutes until completely cured. The resulting foam possessed good adherence properties, suitable for spray foam insulation products. The density of the resultant foam was 1.5 pounds per cubic foot.

### EXAMPLE 16

A bio-based polyurethane foam was prepared by using the following components:

Ratios: A Side: B Side 1:1

| “A” Side Component: | | |
|---|---|---|
| Polymeric MDI | 100.0 | parts by weight |
| (Bayer Product Mondur MR Light) | | |
| “B” Side Component: | | |
| Castor derived Polyol Grade 1 | 35.0 | parts by weight |
| 470 X/P737 (Pelron) | 15.0 | parts by weight |
| H 360/P9157 Polyol (Harvin/Pelron) | 38.5 | parts by weight |
| B 8870 Tegostab (Goldschmidt) | 0.8 | parts by weight |
| DMEA Dimethylethanol Amine (Rhein Chemie) | 1.0 | parts by weight |
| RC-201 (Rhein Chemie) | 1.5 | parts by weight |
| Water | 3.2 | parts by weight |
| Cyclopentane | 5.0 | parts by weight |

The “B” side components are mixed together in a suitable mixing vessel using a specially designed high shear mixer and blending the components for a period of fifteen minutes.

Following the preparation of the B side, the two components were mixed together in a container for about 30 seconds. The reaction of side A with side B resulted in the immediate formation of foam cells, which were allowed to freely rise external to the container. The foam cells bonded to all surfaces of the container and the resultant foam remained “tacky” for approximately 10 minutes until completely cured. The resulting foam possessed good adherence properties, suitable for spray foam insulation products. The density of the resultant foam was 1.7 pounds per cubic foot.

### EXAMPLE 17

A bio-based polyurethane foam was prepared by using the following components:

Ratios: A Side: B Side 1:1

| “A” Side Component: | | |
|---|---|---|
| Polymeric MDI | 100.0 | parts by weight |
| (Bayer Product Mondur MR Light) | | |
| “B” Side Component: | | |
| Castor derived Polyol Grade 1 | 37.0 | parts by weight |
| 470 X/P737 (Pelron) | 15.0 | parts by weight |
| H 360/P9157 Polyol (Harvin/Pelron) | 20.1 | parts by weight |
| B 8870 Tegostab (Goldschmidt) | 1.0 | parts by weight |
| RC-201 | 1.5 | parts by weight |
| TCPP (tris-(chlorisopropyl)phosphate) | 12.0 | parts by weight |
| (Pelron) | | |
| DMEA Dimethylethanol Amine (Rhein Chemie) | 2.0 | parts by weight |
| 0-500 Ortegol (Goldschmidt) | 0.4 | parts by weight |
| Water | 7.0 | parts by weight |
| Cyclopentane | 4.0 | parts by weight |

The “B” side components are mixed together in a suitable mixing vessel using a specially designed high shear mixer and blending the components for a period of fifteen minutes.

Following the preparation of the B side, the two components were mixed together in a container for about 30 seconds. The reaction of side A with side B resulted in the immediate formation of foam cells, which were allowed to freely rise external to the container. The foam cells bonded to all surfaces of the container and the resultant foam remained “tacky” for approximately 10 minutes until completely cured. The resulting foam possessed good adherence properties, suitable for spray foam insulation products. The density of the resultant foam was 1.1 pounds per cubic foot.

1. A group of compositions (solutions) as defined hereunder that produces a series of polyurethane foams comprising of bio-based polyols, hydroxl groups, and water, along with amine catalysts and monomers and surfactants.

2. A composition as in claim 1, wherein at least one water-insoluble, unsaturated hydroxyl acid C₁₈H₃₄O₃ comprising an oil [example 1] formed from castor beans.

3. A composition as in claim 1 an enabling polyol H360/P9157 is used in combination with unsaturated hydroxyls in claim 2.

4. A composition as in claim 1 wherein a diol of polyethylene is used in combination with an unsaturated hydroxyls in claim 2, more preferably containing two hydroxyl groups.

5. A composition as in claim 1 wherein a diol of polyethylene is used in combination with an enabling polyol in claim 3.

6. A composition as in claim 1 wherein a catalyst comprising a solution of triethylene diamine in dipropylene glycol is used in combination with an unsaturated hydroxyl, an enabling polyol and a diol, or a combination thereof.

7. A composition as in claim 1 wherein an tertiary amine catalyst Desmorapid PV is used in combination with a unsaturated hydroxyl, an enabling polyol and a diol, to catalyse the blowing reaction or a combination thereof.

8. A composition as in claim 1 wherein a blowing agent cyclopentane is used in combination with a unsaturated hydroxyl, an enabling polyol, a diol, and a tertiary amine, or a combination thereof.

9. A composition as in claim 1, further comprising polymeric methane diisocyanate, a surfactant [siloxanes 9900] , or a combination thereof.

10. A polymeric composition as in claim 1, further comprising a polyurethane, having:
at least one bio-based oil [castor];
at least one filler material;
at least one surfactant;
at least one stabilizer;
at least one solvent, cross-linker; [[PEG 400/DEG/DPG]
at least one drying agent, catalyst; [RC 105]
at least one stabilizer; [TEA]
at least one fire retardant [TCPP]
at least one isocyanate;
(above some or all) components of examples 1, 2, 4, 9, 15, 16 and 17,
at least one polymerization catalyst [RC108 example 3]

11. The polymer composition of claim 11, wherein the at least one oil comprises bio-based castor derived oil wherein the oil comprises by weight between about 20% to 43% of the polymer composition.

12. The polymer composition of claim 11, wherein the at least one resin comprising a enabling polyol resin wherein the resin comprises by weight between about 20% to 41% of the polymer composition.

13. The polymer composition of claim 11, wherein the water content to enable the reaction with the isocyanate component comprises by weight between 0.6% to 10% of the polymer composition.

14. The polymer composition of claim 11, wherein the at least one isocyanate comprising 4,4′-dephenyl methane diisocyanate (MDI) wherein the MDI comprises by weight between about 50% of the polymer composition.

15. The polymer composition of claim 11, wherein the at least one[solvent cross-linking agent] comprising PEG400/DMA wherein the [solvent cross-linker] comprises by weight between about 0.1% to 0.3% of the polymer composition.

16. The polymer composition of claim 11, wherein the at least one polymerizing catalyst comprising tertiary amines wherein the polymerizing catalyst comprises by weight between about 0.1% to 2.3% of the polymer composition.

17. A polymeric composition as in claim 1, further comprising a polyurethane, having at least two component parts comprising:
Side A Component
at least one ester of isocyanic acid
Side B Component
at least one soy bean based oil
a specific amount of filtered water to react with the isocyanate to form carbon dioxide (the primary gas for expansion of the foam).

18. A polymeric composition as in claim 1, further comprising a polyurethane, having:
at least one bio-based oil [soybean derived];
at least one filler material soybean epoxidized oil;
at least one surfactant;
at least one stabilizer;
at least one solvent, cross-linker; [[PEG 400/DEG/DPG]
at least one drying agent, catalyst; [RC1 05]
at least one stabilizer; [TEA]
at least one fire retardant [TCPP]
at least one isocyanate;
(above some or all) components of examples 3, 5, 6, 7, 8, 10, 11, 12, 13, 14 and 17,
at least one polymerization catalyst [RC108 example 3]
